(19) United States
(12) Patent Application Publication
(10) Pub. No.: US 2023/0123801 A1
(43) Pub. Date: Apr. 20, 2023

(54) LIQUID CHROMATOGRAPH

(71) Applicant: HITACHI HIGH-TECH SCIENCE CORPORATION, Tokyo (JP)

(72) Inventors: Norimasa MINAMOTO, Tokyo (JP); Yusuke HOSEN, Tokyo (JP); Kiyotoshi MORI, Tokyo (JP); Masahito ITO, Tokyo (JP)

(21) Appl. No.: 17/937,341

(22) Filed: Sep. 30, 2022

(30) Foreign Application Priority Data
Oct. 19, 2021 (JP) 2021-171218

(51) Int. Cl. G01N 30/30; G01N 30/96; G01N 30/38

(52) U.S. Cl. CPC G01N 30/30; G01N 30/96; G01N 30/38; G01N 2030/027

(57) ABSTRACT

A liquid chromatograph includes a liquid feeding portion, a sample injection portion, a separation column, a first temperature adjustment device which raises temperature of the separation column to a first temperature, a detector, a second temperature adjustment device which is provided upstream of the separation column and adjusts temperature of a mobile phase to a second temperature lower than the first temperature, and a control device which controls at least one of the liquid feeding portion and the second temperature adjustment device. The control device controls at least one of the liquid feeding portion and the second temperature adjustment device such that the mobile phase adjusted to the second temperature is fed to the separation column before a next sample is injected after separation of sample components by the separation column ends.

This application claims the benefit of Japanese Patent Application No. 2021-171218, filed Oct. 19, 2021, which is hereby incorporated by references in its entirety into this application.

### BACKGROUND OF THE INVENTION

### Field of the Invention

The present disclosure relates to a liquid chromatograph.

### Description of Related Art

Regarding a method for analyzing sample components in a sample, liquid chromatography is known. In liquid chromatography, from a viewpoint of improvement or the like in performance when separating sample components, the temperature of a separation column is adjusted.

For example, Patent Literature 1 discloses a technology of performing temperature control for a separation column for making a detection baseline stable.

In addition, Patent Literature 2 discloses a heating device for performing preheating before a mobile phase is introduced into a separation column.

### Patent Documents

[Patent Literature 1] U.S. Pat. No. 6,601,439

[Patent Literature 2] United States Patent Application Publication No. 2007/0181702

### SUMMARY OF THE INVENTION

Incidentally, in liquid chromatography, a separation performance is generally improved by raising the temperature of a separation column during a step of separating sample components using the separation column. In this case, after the separating step, the temperature of the separation column is reduced in preparation for the next analysis before a next sample is injected. For example, a cold air circulation-type or an aluminum block heat conduction-type temperature adjustment device is used for adjusting the temperature of such a separation column.

However, in such a temperature adjustment device, there is a problem that it takes time to reduce the temperature of a separation column.

In addition, the technologies of Patent Literature 1 and Patent Literature 2 are aimed at making a detection baseline of a separation column stable or heating a mobile phase, and thus there is a problem that it is difficult to apply them to reduction of the temperature of the separation column described above.

Hence, in the present disclosure, in a liquid chromatograph, an analysis time is shortened by quickly reducing temperature of a separation column after a separating step.

A liquid chromatograph according to an embodiment of the present disclosure includes a liquid feeding portion which feeds a mobile phase to a flow channel, a sample injection portion which is provided downstream of the liquid feeding portion in the flow channel and injects a sample into the mobile phase, a separation column which is provided downstream of the sample injection portion in the flow channel and separates sample components in the sample, a first temperature adjustment device which raises temperature of the separation column to a first temperature during separation of the sample components by the separation column, and a detector which is provided downstream of the separation column in the flow channel and detects sample components separated by the separation column. The liquid chromatograph further includes a second temperature adjustment device which is provided upstream of the separation column in the flow channel and adjusts temperature of the mobile phase to a second temperature lower than the first temperature, and a control device which controls at least one of the liquid feeding portion and the second temperature adjustment device. The control device controls at least one of the liquid feeding portion and the second temperature adjustment device such that the mobile phase adjusted to the second temperature is fed to the separation column before the next sample is injected after separation of the sample components by the separation column ends.

According to the present disclosure, in a liquid chromatograph, an analysis time can be shortened by quickly reducing temperature of a separation column after a separating step.

Problems, constitutions, and effects other than those described above will be made clear by description of the following embodiment and Examples.

### BRIEF DESCRIPTION OF THE DRAWINGS

FIG. 1 is a schematic view of a device constitution and flow channels of an amino acid analyzer 100 according to Example 1.

FIG. 2 is a schematic view of a time table in a time program for controlling operation of the amino acid analyzer 100 according to Example 1.

FIG. 3 is a graph illustrating an example of temperature change over time in a separation column of the amino acid analyzer 100 according to Example 1.

FIG. 4 is a view of the amino acid analyzer 100 according to Example 2 corresponding to that in FIG. 1.

FIG. 5 is a view of the amino acid analyzer 100 according to Example 3 corresponding to that in FIG. 1.

FIG. 6 is a view of the amino acid analyzer 100 according to Example 4 corresponding to that in FIG. 1.

FIG. 7 is a view of the amino acid analyzer 100 according to Example 5 corresponding to that in FIG. 1.

FIG. 8 is a view of the amino acid analyzer 100 according to Example 6 corresponding to that in FIG. 1. FIG. 9 is a view of the amino acid analyzer 100 according to Example 7 corresponding to that in FIG. 1.

FIG. 10 is a view of the amino acid analyzer 100 according to Example 7 corresponding to that in FIG. 2.

### DETAILED DESCRIPTION OF THE INVENTION

Hereinafter, an embodiment of the present disclosure will be described. Essentially, the following description of a preferable embodiment is merely an example and is not intended to limit the present disclosure, applications thereof, or the purpose thereof at all.

### Liquid Chromatograph

A liquid chromatograph is a device which separates target components of a sample using a separation column while feeding a mobile phase, detects components flowing in a separation order using a detector such as a spectrophotometer, and analyzes the components of the sample. Examples of the liquid chromatograph according to the present disclosure include a high performance liquid chromatograph (HPLC) and an ultra-high performance liquid chromatograph (UHPLC), and although it is not intended to be limited, an HPLC is preferably adopted.

In a liquid chromatograph, in order to separate hydrophilic components, hydrophobic components, ionic components, and the like in a sample, separation columns in various separation modes such as a normal phase mode, a reversed phase mode, and an ion exchange mode are used. The separation mode of the liquid chromatograph according to the present disclosure is not intended to be limited, but it is preferably a reversed phase mode and an ion exchange mode and is more preferably an ion exchange mode.

The kind of a stationary phase of the separation column and the kind of the mobile phase vary depending on the separation mode.

Specifically, normal phase chromatography is a method in which a mobile phase such as an organic solvent having a low polarity is caused to flow on a stationary phase such as a silica gel having a high polarity and components are eluted in order from those having the lowest polarity.

Reversed phase chromatography is a method in which a mobile phase such as water, methanol, or acetonitrile having a high polarity is caused to flow on a stationary phase such as a C18 silica column or a C30 silica column having a low polarity and components are eluted in order from those having the lowest hydrophobicity.

Ion exchange chromatography is a method for separating and analyzing sample components having different properties utilizing an interaction occurring with respect to the sample components in two phases such as a stationary phase consisting of ion exchangers such as an ion exchange resin and a mobile phase consisting of a buffer solution or the like. Ion exchangers have chemically-modified ion exchange groups and include cation exchangers such as a sulfonic acid or a carboxylic acid and anion exchangers such as quaternary ammonium or tertiary ammonium.

Specifically, for example, an ion exchange chromatograph is an amino acid analyzer which is used for analysis of an amino acid composition of proteins and peptides and analysis of amino acids, analog substances thereof, and the like of a drug, a biological fluid, and the like; an HPLC system which is used for analysis of proteins, amines, organic acids, and the like; or the like. An amino acid analyzer is preferably adopted.

Examples of a sample to be analyzed by an ion exchange chromatograph include amino acids.

In amino acid simultaneous analysis in which various kinds of amino acids are simultaneously analyzed, amino acids and amino acid analog substances (objects to be analyzed) can be classified into approximately 20 kinds of protein hydrolysate amino acids and 40 or more kinds of biological fluid amino acids and amino acid analog substances in broad classification. These various kinds of amino acids can be simultaneously analyzed by mixing a plurality of buffer solutions, adding a sample to the mixed buffer solutions, and performing detection after causing the sample to pass through a separation column.

The liquid chromatograph according to the present disclosure may be a device for analyzing sample components by a gradient elution method. In this case, regarding the mobile phase for separation, a plurality of kinds of eluents are used. In this specification, the term “gradient” is used as a term including a stepwise gradient, a curved gradient, and a linear gradient.

The liquid chromatograph according to the present disclosure includes a liquid feeding portion, a sample injection portion, a separation portion, a detector, and a control device in the order from upstream of a flow channel. In addition, the liquid chromatograph includes a second temperature adjustment device provided upstream of the separation column in the flow channel. The liquid chromatograph may include other arbitrary constituents in addition to these constituents. Specifically, for example, from a viewpoint of facilitating detection of sample components, a reagent for pre-column derivatization or post-column derivatization and devices such as a pump, a mixer, and a reaction column may be included.

### Liquid Feeding Portion

The liquid feeding portion feeds a mobile phase to the flow channel.

When the gradient elution method is used, the liquid feeding portion feeds, as mobile phases for separation, two or more kinds of eluents including a first eluent and a second eluent which starts to be fed after the first eluent to the flow channel. In addition, as mobile phases, the liquid feeding portion may be able to feed mobile phases which are not used for separating a sample, such as a column cleaning liquid for cleaning the separation column and an adjustment liquid for adjusting the state of the separation column. Cleaning of a column may be expressed as regeneration of a column, and a cleaning liquid may also be referred to as a regeneration liquid.

An eluent varies depending on the separation mode of the liquid chromatograph. It is an organic solvent or the like having a low polarity in the normal phase mode, a polar solvent or the like in the reversed phase mode, and a buffer solution such as a sodium citrate buffer solution or a lithium citrate buffer solution in the ion exchange mode, for example. Regarding the eluent and the column cleaning liquid, any of liquids generally used for liquid chromatography can be used.

Regarding the adjustment liquid, any of liquids generally used for liquid chromatography can be used. Specifically, for example, a low-salt concentration aqueous solution can be utilized in the ion exchange mode. When the stationary phase of the separation column is a cation exchanger, a low-pH aqueous solution can be utilized. When the stationary phase of the separation column is an anion exchange resin, a high-pH aqueous solution, pure water such as distilled water, or the like can be utilized. In the case of the ion exchange mode, the salt concentration of the adjustment liquid is preferably lower than the salt concentration of the eluent. In addition, in the case of the ion exchange mode, from a viewpoint of quickly shifting the salt concentration of the separation column to an initial state, pure water is more preferably used as the adjustment liquid. In addition, when the stationary phase of the separation column is a cation exchanger, and when the foregoing low-pH aqueous solution is used as the adjustment liquid, the pH of the low-pH aqueous solution is preferably lower than the pH of the eluent. When the stationary phase of the separation column is an anion exchange resin, and when the foregoing high-pH aqueous solution is used as the adjustment, the pH of the high-pH aqueous solution is preferably higher than the pH of the eluent.

When the gradient elution method is used, the first eluent of two or more kinds of eluents is an eluent which is introduced first into the separation column. The first eluent is introduced into the separation column at least in a pre-injection liquid feeding step (which will be described below) and preferably in a cooling step and the pre-injection liquid feeding step. Therefore, the first eluent plays a role of making the separation column stable in addition to a role as an eluent contributing to separation of sample components. On the other hand, the second eluent may play a greater role in contributing to separation of sample components than the first eluent and may not play a role of making the separation column stable.

When the separation mode is the ion exchange mode, the salt concentration of the first eluent is preferably lower than the salt concentration of the second eluent. Accordingly, the separation column can be effectively made stable. In such a manner, a performance when separating sample components using the remaining eluent including the second eluent can be improved. In this specification, “a salt concentration” means a cation concentration or an anion concentration included in an eluent. Specifically, the salt concentration of the first eluent is preferably equal to or higher than 0.05 N and lower than 0.2 N and is more preferably within a range of 0.12 N to 0.19 N. The salt concentration of the second eluent is preferably higher than 0.16 N and lower than 1.2 N and is more preferably within a range of 0.2 N to 1 N.

In addition, when the separation mode is the ion exchange mode, the difference between the pH of the first eluent and the pH of the second eluent is preferably within 0.5 and is more preferably within 0.3. When the stationary phase of the separation column (which will be described below) is a cation exchange resin, the pH of the first eluent is more preferably higher than the pH of the second eluent. Accordingly, the separation column can be effectively made stable. In such a manner, a performance when separating sample components using the remaining eluent including the second eluent can be improved.

When the separation mode is the ion exchange mode and the stationary phase of the separation column (which will be described below) is a cation exchanger, the pH of the first eluent and the second eluent is near 3. Specifically, it is preferably within a range of 2.5 to 3.5. In addition, in this case, when an eluent includes three or more kinds of eluents, the pH of a third eluent which starts to be fed after the second eluent is preferably higher than the pH of the first eluent and the second eluent.

Specifically, for example, the liquid feeding portion is constituted of containers which store the respective mobile phases such as the eluent, the column cleaning liquid, and the adjustment liquid; electromagnetic valves which start and end feeding of the mobile phases inside the respective containers to the flow channels and adjust flow rates of the respective liquids; a pump which feeds the mobile phases in the respective containers to the flow channels and adjusts flow speeds of the respective mobile phases; and the like. The electromagnetic valves can be provided in a manner of corresponding to the respective containers on the flow channel provided in a manner of corresponding to the respective containers. The pump can be provided downstream of the foregoing electromagnetic valves on the flow channels. Specifically, for example, the flow channels corresponding to the respective containers may join together on the downstream side of the electromagnetic valves and form one flow channel, and one pump may be installed on this flow channel (low-pressure gradient elution). In addition, a plurality of pumps may be provided in a manner of corresponding to the respective containers on the flow channels corresponding to the respective containers (high-pressure gradient elution).

### Sample Injection Portion

The sample injection portion is a means which is provided downstream of the liquid feeding portion in the flow channel and injects a sample into a mobile phase flowing in the flow channel. The sample injection portion may be a manual-type manual injector or may be an automatic-type auto-sampler. However, from a viewpoint of accurately controlling an injection timing and an injection amount of a sample, it is preferably an auto-sampler.

### Separation Portion

The separation portion includes a separation column which is provided downstream of the sample injection portion in the flow channel and separates sample components in a sample, and a first temperature adjustment device which raises the temperature of the separation column to a first temperature during separation of sample components by the separation column.

The separation column is not particularly limited, and a column generally used for liquid chromatography can be used. When the separation mode is the ion exchange mode, the stationary phase of the separation column may be a cation exchanger such as a cation exchange resin or may be an anion exchanger such as an anion exchange resin. However, it is preferably a cation exchanger and is more preferably a cation exchange resin.

The first temperature adjustment device is not particularly limited as long as it is a device which can raise the temperature of the separation column to the first temperature, and for example, it is a known device such as a heater, a Peltier element, or a heat pump. The first temperature adjustment device may be provided in the separation column and may be constituted to be provided in the flow channel upstream of the separation column and raise the temperature of a mobile phase fed to the separation column. The first temperature may be temperature employed in general liquid chromatography. Although it is not intended to be limited, specifically, for example, it can be 60° C. or higher and can be preferably within a range of 70° C. to 100° C.

### Detector

The detector is a device which is provided downstream of the separation column in the flow channel and detects sample components separated by the separation column. The detector is not particularly limited, and for example, it is possible to use a detector, such as an electrical conductivity detector, a UV/visible light absorbance detector, a fluorescence detector, or an electrochemical detector, which can be generally used for liquid chromatography.

### Second Temperature Adjustment Device

The second temperature adjustment device is a device which is provided upstream of the separation column in the flow channel and adjusts the temperature of the mobile phase to a second temperature lower than the first temperature.

The second temperature adjustment device is not limited as long as it is a device which can adjust the temperature of the mobile phase to the second temperature, and for example, it is a known device such as a Peltier refrigerator, a Peltier element, a compressor refrigerator, a low-temperature thermostatic water circulation device, or a liquefied carbon dioxide cylinder utilizing cooler. The second temperature adjustment device may be installed on containers storing the respective mobile phases, for example, as long as the location is upstream of the separation column, and for example, it may be installed on flow channels between the respective containers and the pump, on a flow channel between the liquid feeding portion and the sample injection portion, on a flow channel between the sample injection portion and the separation column, or the like. In addition, for example, when an arbitrary element such as an ammonia filter column is disposed on a flow channel between the liquid feeding portion and the sample injection portion, the second temperature adjustment device may be installed on the arbitrary element.

A mobile phase subjected to temperature adjustment by the second temperature adjustment device may be any of an eluent, a column cleaning liquid, and an adjustment liquid. When the gradient elution method is used, the second temperature adjustment device preferably adjusts the temperature of any of the first eluent, the column cleaning liquid, and the adjustment liquid.

The second temperature is temperature lower than the first temperature. From a viewpoint of improving a temperature reduction rate of the separation column, the second temperature is preferably lower. However, it is preferably temperature at which the mobile phase is not solidified. In addition, the second temperature is preferably equal to or lower than an initial temperature of the separation column before the separating step and is more preferably lower than the initial temperature. Accordingly, temperature reduction of the separation column can be accelerated. Although it is not intended to be limited, specifically, for example, the second temperature can be within a range of 0° C. to 40° C., be preferably within a range of 0° C. to 25° C., and be more preferably within a range of 0° C. to 20° C.

### Control Device

The control device is a device for controlling at least one of the liquid feeding portion and the second temperature adjustment device.

Specifically, for example, the control device is electrically connected to the electromagnetic valves and the pump of the liquid feeding portion, and the sample injection portion, the first temperature adjustment device, the second temperature adjustment device, and the like in the case of the auto-sampler by radio or through a cable. The control device controls operation of these by sending a control signal thereto. In addition, for example, the control device is also electrically connected to the detector and the like by radio or through a cable. For example, the control device acquires detection results of the detector and outputs the results as a chromatogram and data. For example, the control device is a device based on a known microcomputer and includes an input portion which inputs information from the outside, a storage which stores the information, a computation portion which performs various kinds of computation on the basis of various kinds of information, an output portion such as a display portion which outputs information, and the like.

The storage of the control device stores a time program for executing an analyzing step (which will be described below). The time program includes time tables corresponding to the respective steps included in the analyzing step (which will be described below). When the gradient elution method is used, the time program includes a gradient elution time program in which the mixing ratio of an eluent is varied and the eluent is fed to the liquid feeding portion. That is, in the liquid chromatograph in which analysis is performed using the gradient elution method, the control device varies the mixing ratio of two or more kinds of eluents on the basis of the gradient elution time program and feeds the mixed eluent to the liquid feeding portion.

### Analyzing Step of Liquid Chromatograph

The analyzing step of a liquid chromatograph includes a sample injecting step, a separating step, a cooling step, and a pre-injection liquid feeding step. These steps are repeated as one method as many times as set by a user. In addition, the analyzing step may include at least one of a cleaning step and an adjusting step after the separating step and before the pre-injection liquid feeding step as described below.

The sample injecting step is a step in which a sample is injected into a flow channel by the sample injection portion. Although it is not intended to be limited, the time program may be prepared with the sample injecting step set as a time zero.

The separating step is a step of separating sample components of a sample in the separation column after the sample injecting step. When the gradient elution method is used, at least in the separating step, an eluent is fed on the basis of the gradient elution time program described above.

In the separating step, from a viewpoint of improving a separation performance by the separation column, the temperature of the separation column is raised to the first temperature by the first temperature adjustment device. That is, the temperature of the separation column at the time when the separating step ends is raised to the first temperature.

When the separating step ends, for the next method, the state of the separation column needs to be shifted to a state before the sample is injected, that is, the initial state and be made stable. The cooling step and the pre-injection liquid feeding step after the separating step are provided therefor.

In the cooling step, regarding a mobile phase for the cooling step, for example, the temperature of the separation column is reduced by feeding an eluent subjected to temperature adjustment to the second temperature, an anti-freezing fluid such as a mixed solution of water and alcohol, and the like, and preferably the first eluent.

Moreover, in the pre-injection liquid feeding step, before the sample injecting step for the next method, the separation column is made stable by feeding at least the first eluent.

After the separating step and before the pre-injection liquid feeding step, at least one of the cleaning step and the adjusting step may be provided.

The cleaning step is a step of cleaning the separation column by feeding a column cleaning liquid.

The adjusting step is a step of adjusting the state of the separation column by feeding an adjustment liquid.

The mobile phase fed in the cooling step and subjected to temperature adjustment to the second temperature may be at least one of the column cleaning liquid and the adjustment liquid described above. When the column cleaning liquid is used, the cooling step may also include the cleaning step. In addition, when the adjustment liquid is used, the cooling step may also include the adjusting step. In such a manner, the temperature of the separation column, the salt concentration, and the state of the pH and the like can be quickly shifted to the initial state and made stable.

### Method for Controlling Liquid Chromatograph

The liquid chromatograph of the present disclosure has the following features.

The control device controls at least one of the liquid feeding portion and the second temperature adjustment device such that the mobile phase adjusted to the second temperature is fed to the separation column after separation of sample components by the separation column ends and before a next sample is injected. That is, the control device executes the time program such that the mobile phase adjusted to the second temperature is fed to the separation column in the cooling step.

For example, when the second temperature adjustment device is installed on a container of the mobile phase, the electronic valve corresponding to the container is opened, and the mobile phase adjusted to the second temperature is fed to the separation column. In addition, for example, when the second temperature adjustment device is installed on the flow channels between the respective containers and the pump, on the flow channel between the liquid feeding portion and the sample injection portion, on the flow channel between the sample injection portion and the separation column, or the like, the electronic valve corresponding to the mobile phase fed in the cooling step is opened, and the second temperature adjustment device is controlled such that the mobile phase is adjusted to the second temperature.

As described above, the temperature of the separation column at the time when the separating step ends is raised to the first temperature. In order to execute the analyzing step for the next method, the temperature of the separation column needs to be reduced to the initial temperature before the separating step.

In the related art, in order to reduce the temperature of the separation column after the separating step, the separation column is cooled using a temperature adjustment device of a cold air circulation-type or an aluminum block heat conduction-type. However, in such a temperature adjustment device, it takes time for temperature reduction of the separation column.

In the liquid chromatograph according to the present disclosure, in the cooling step, the mobile phase which has been adjusted to the second temperature lower than the first temperature is fed to the separation column. Accordingly, since the mobile phase adjusted to the second temperature comes into direct contact with the stationary phase inside the separation column, the temperature of the separation column can be more quickly reduced to the second temperature than that in the related art. In such a manner, the temperature of the separation column can be quickly shifted to the initial temperature, and the analysis time of the liquid chromatograph can be shortened.

In addition, temperature control of the first temperature adjustment device in steps other than the cooling step, particularly in the pre-injection liquid feeding step and the separating step is preferably fine control. Particularly, in the pre-injection liquid feeding step, it is desirable to perform fine control causing the separation column to be in a highly accurate thermostatic state for the next sample injection. On the other hand, the temperature control of the second temperature adjustment device in the cooling step may be coarse control. Accordingly, the liquid chromatograph according to the present disclosure can include both a quick cooling ability after the separating step and a highly accurate temperature management ability of the separation column suitable for analysis. The foregoing coarse control can be control within a temperature error range of approximately 5 to 10 times compared to the foregoing fine control.

### EXAMPLES

Hereinafter, an amino acid analyzer 100 (liquid chromatograph) and a controlling method therefor according to Examples of the present disclosure will be described using the drawings.

### Example 1

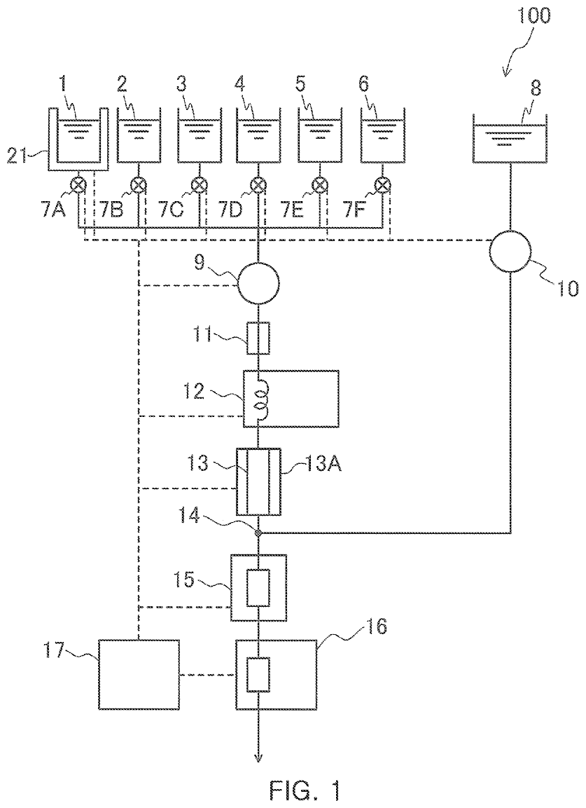

FIG. 1 is a schematic view of a device constitution and flow channels of the amino acid analyzer 100 according to Example 1 of the present disclosure.

In the amino acid analyzer 100, as mobile phases, a first eluent 1 to a fourth eluent 4, distilled water 5, and column cleaning liquids 6 (which may also be individually referred to as “a B1 liquid” to “a B6 liquid”) can be installed. Any of liquids is selected from these by electromagnetic valves 7A to 7F and is fed by a mobile phase pump 9. The eluents are introduced into a separation column 13 via an ammonia filter column 11. An auto-sampler 12 (sample injection portion) is provided downstream of the ammonia filter column 11 and upstream of the separation column 13, and an amino acid sample is injected into the eluents in the flow channels by the auto-sampler 12. The injected amino acid sample arrives at the separation column 13 together with the eluents and is separated in the separation column 13.

The amino acid analyzer 100 also includes a ninhydrin reagent 8 and a ninhydrin pump 10 for feeding the ninhydrin reagent 8. Each of the amino acid components separated in the separation column 13 is mixed with the ninhydrin reagent 8, which has been sent by the ninhydrin pump 10, by a mixer 14 and reacts in a heated reaction column 15.

Amino acids manifesting color development (Ruhemann's purple) due to reaction are continuously detected by a detector 16, are output by a data processing device 17 (control device) as a chromatogram and data, and are recorded and saved.

A Peltier refrigerator 21 (second temperature adjustment device) for adjusting the temperature of the B1 liquid is installed on a container storing the B1 liquid. Temperature adjustment devices for adjusting the temperatures of the mobile phases may also be included in the containers of the B2 liquid to the B6 liquid. In addition, a first temperature adjustment device 13A for adjusting the temperature of the separation column 13 is provided in the separation column 13. A temperature adjustment device (not illustrated) for adjusting the temperature thereof may also be provided in the reaction column 15 and the like.

The data processing device 17 controls the electromagnetic valves 7A to 7F of the respective containers storing the respective mobile phases such as the B1 liquid to the B6 liquid, the mobile phase pump 9, the ninhydrin pump 10, the auto-sampler 12, the first temperature adjustment device 13A, the Peltier refrigerator 21, and the temperature adjustment device (not illustrated) for adjusting the temperatures of the containers of the respective mobile phases, the reaction column 15, and the like. This control is mainly executed by the time program stored in the storage (not illustrated) of the data processing device 17.

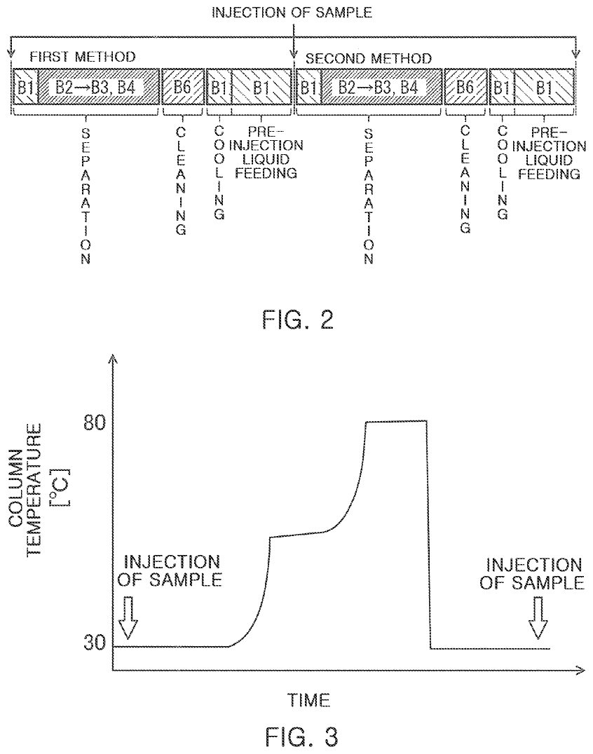

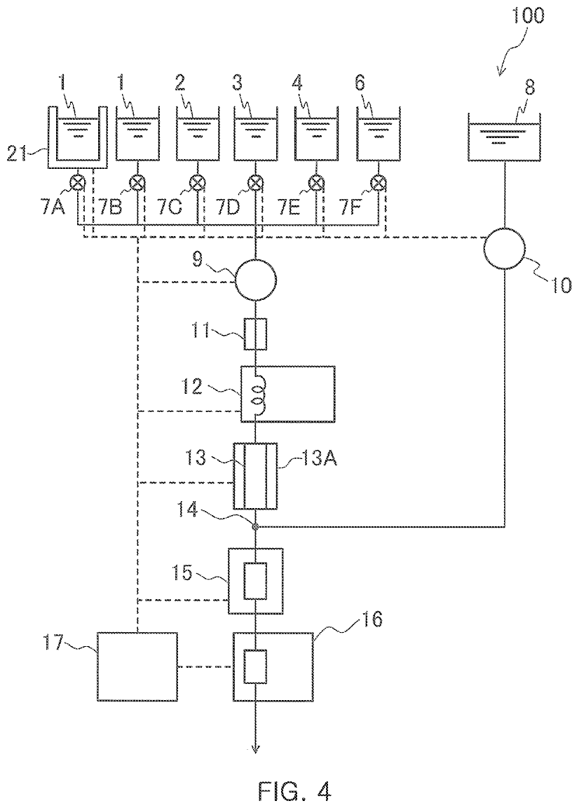

FIG. 2 is a schematic view of a time table in a time program of the amino acid analyzer 100. In addition, FIG. 3 illustrates an example of temperature change over time in the separation column 13 of the amino acid analyzer 100 in the analyzing step.

As illustrated in FIG. 2, in the sample injecting step, the separating step starts when a sample is injected into the flow channel by the auto-sampler 12. In the separating step, the third eluent 3 (B3 liquid) and the fourth eluent 4 (B4 liquid) are fed to the separation column 13 in order from the first eluent (B1 liquid) via the second eluent 2 (B2 liquid) on the basis of the gradient elution time program while varying the mixing ratio. In such a manner, separation of sample components is performed. When all sample components of objects to be analyzed are eluted and the separating step ends, the cleaning step starts, the column cleaning liquid 6 (B6 liquid) is fed, and cleaning of the separation column 13 is performed.

As illustrated in FIG. 3, when the separating step starts, the temperature of the separation column 13 which has been approximately 30° C. (initial temperature) gradually rises during the separating step due to heating of the first temperature adjustment device 13A, and the temperature thereof is in a state in which it rises to approximately 80° C. (first temperature) at the time when the separating step and the cleaning step end.

When the cleaning step ends, the cooling step starts. In the cooling step, the B1 liquid cooled by the Peltier refrigerator 21 is fed to the separation column 13.

In details, in the amino acid analyzer 100 in FIG. 1, the temperature of the B1 liquid is retained at approximately 30° C. (second temperature) by the Peltier refrigerator 21. After the cleaning step ends, the B1 liquid which has been subjected to temperature adjustment is fed to the separation column 13. Accordingly, as illustrated in FIG. 3, the temperature of the separation column 13 after the cleaning step ends is rapidly reduced. In such a manner, the temperature of the separation column 13 can be quickly shifted to the initial temperature before the separating step.

In the present Example, throughout the entire one method, the temperature of the B1 liquid is retained at approximately 30° C. (initial temperature) by the Peltier refrigerator 21, but it is not limited to this constitution. For example, when the temperature of the separation column 13 is sufficiently reduced, the temperature control by the Peltier refrigerator 21 may end. In this case, prior to the cooling step, that is, for example, during a period from the latter half of the separating step to a time in the middle of the cleaning step or the like, the Peltier refrigerator 21 need only be controlled such that the temperature of the B1 liquid is retained at approximately 30° C. (second temperature). In addition, the Peltier refrigerator 21 may be controlled such that the temperature of the B1 liquid is adjusted to the second temperature lower than the initial temperature prior to the cooling step and is adjusted to the initial temperature or the like after the cooling step. When the temperature is sufficiently reduced, the temperature control can end. However, as illustrated in FIG. 2, it is desirable that the time program be constant. This is because the mobile phases need to be fed at constant intervals in order to make time change cycles of the concentration and the pH constant.

In the cooling step, it is preferable that the temperature adjustment device provided in the separation column 13 also end temperature adjustment or be set to the initial temperature or the like. Accordingly, the separation column 13 is quickly reduced.

When the cooling step ends, the pre-injection liquid feeding step starts. The pre-injection liquid feeding step is a step of feeding at least the B1 liquid to the separation column 13 before the sample injecting step. Accordingly, the separation column 13 can be made stable before the sample is injected. The B1 liquid fed in the pre-injection liquid feeding step may be adjusted to the initial temperature or the like or may be retained at a normal temperature. In the pre-injection liquid feeding step, it is preferable that the temperature of the separation column 13 be adjusted to the initial temperature by the temperature adjustment device.

### Example 2

Hereinafter, other Examples according to the present disclosure will be described in detail. In description of these Examples, the same reference signs are applied to the same parts as those in Example 1, and detailed description thereof will be omitted.

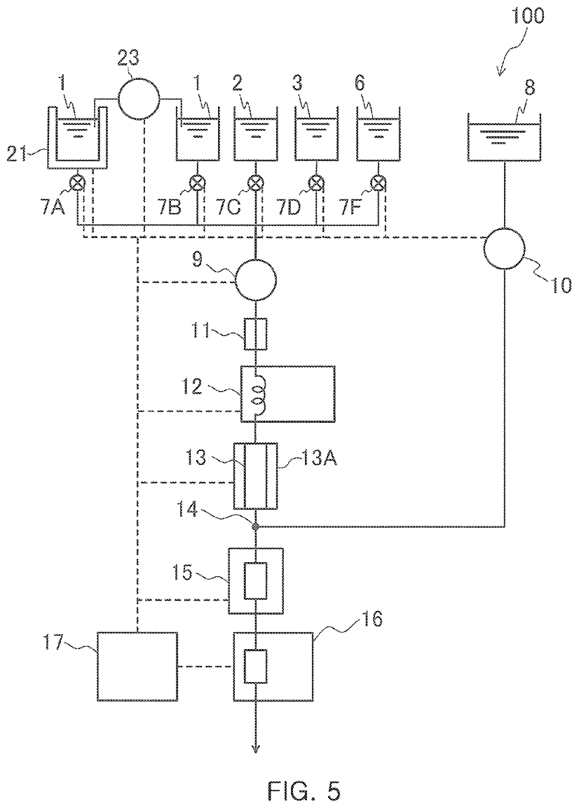

FIG. 4 is a schematic view of the device constitution and the flow channels of the amino acid analyzer 100 according to Example 2 of the present disclosure.

In Example 2, regarding the B1 liquid, two kinds of liquids such as the B1 liquid subjected to temperature adjustment by the Peltier refrigerator 21 and the B1 liquid at a normal temperature are installed.

In this constitution, by switching between the electromagnetic valves 7A and 7B, the B1 liquid subjected to temperature adjustment by the Peltier refrigerator 21 may be fed in the cooling step, and the B1 liquid at a normal temperature may be fed in the pre-injection liquid feeding step and the separating step. Accordingly, for example, while having the second temperature as temperature lower than the initial temperature, temperature reduction of the separation column can be further accelerated.

### Example 3

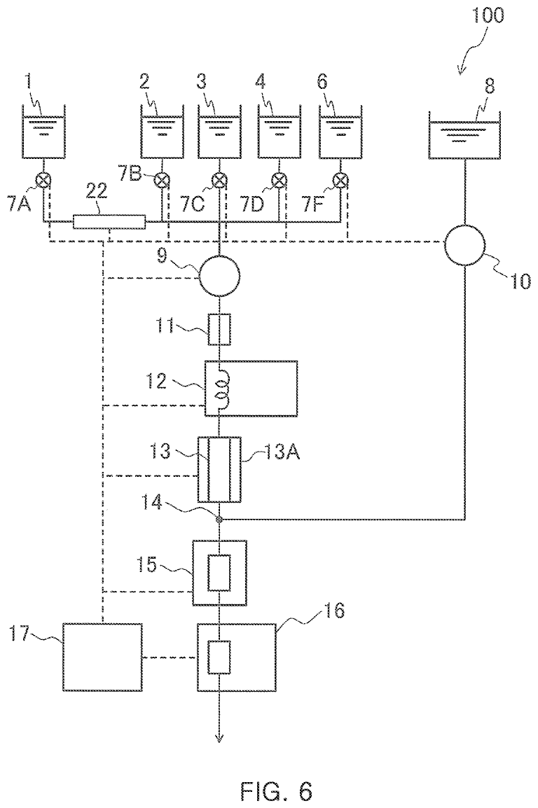

FIG. 5 is a schematic view of the device constitution and the flow channels of the amino acid analyzer 100 according to Example 3 of the present disclosure.

In Example 3, the B1 liquid to the B3 liquid are installed as eluents. There are two containers storing the B1 liquid, and the B1 liquid stored in one container is fed to the other container as necessary by a pump 23. The Peltier refrigerator 21 is installed on the other container, and the B1 liquid fed to the other container is subjected to temperature adjustment by the Peltier refrigerator 21.

Regarding the pump 23, although it is not intended to be limited, for example, a general low-cost liquid feeding pump such as a roller pump can be used. The pump 23 is controlled by the data processing device 17.

In this constitution, due to liquid feeding by the pump 23 and switching between the electromagnetic valves 7A and 7B, the B1 liquid subjected to temperature adjustment by the Peltier refrigerator 21 is fed in the cooling step, and the B1 liquid at a normal temperature is fed in the pre-injection liquid feeding step and the separating step. Specifically for example, during the cleaning step, a part of the B1 liquid inside one container is fed into the other container by the pump 23, and the B1 liquid inside the other container is fed to the separation column 13 when the cooling step starts. When the cooling step ends, the B1 liquid inside one container is fed by closing the electromagnetic valve 7A and opening the electromagnetic valve 7B. According to this constitution, similar to Example 3, for example, while having the second temperature as temperature lower than the initial temperature, temperature reduction of the separation column can be further accelerated.

### Example 4

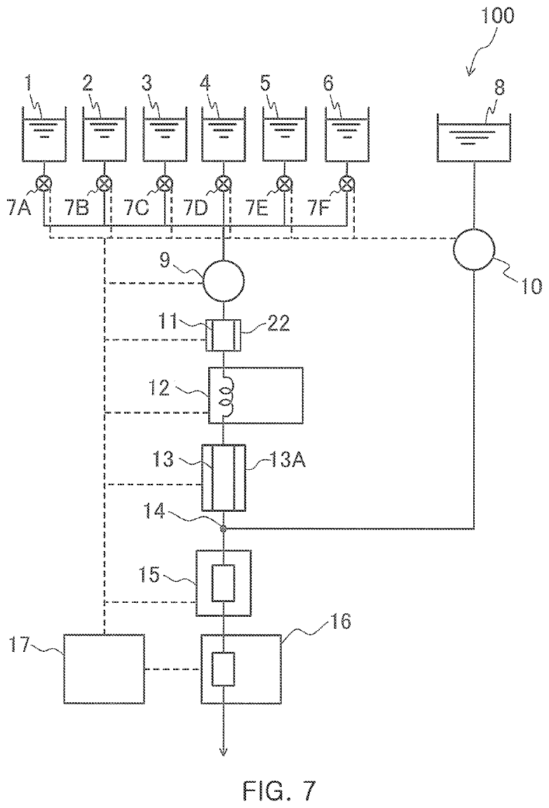

FIG. 6 is a schematic view of the device constitution and the flow channels of the amino acid analyzer 100 according to Example 4 of the present disclosure.

In Example 4, a Peltier element 22 is installed on the flow channel between the electromagnetic valve 7A and the mobile phase pump 9. Specifically, for example, the Peltier element 22 is installed in a member forming the flow channel via an aluminum block and the like and is controlled by the data processing device 17. The Peltier element 22 can perform temperature adjustment of the B1 liquid flowing inside the flow channel in a state in which the electromagnetic valve 7A is opened.

In this constitution, in the cooling step, the B1 liquid subjected to temperature adjustment by the Peltier element 22 is fed to the separation column. In the pre-injection liquid feeding step, for example, temperature adjustment by the Peltier element 22 may end, or the temperature of the Peltier element 22 may be set to the initial temperature.

### Example 5

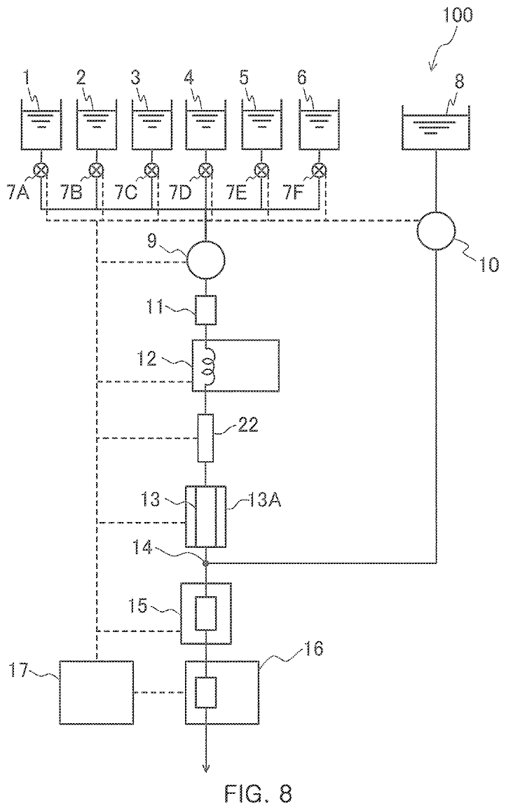

FIG. 7 is a schematic view of the device constitution and the flow channels of the amino acid analyzer 100 according to Example 5 of the present disclosure.

As illustrated in FIG. 7, the Peltier element 22 may be installed on the flow channel between the mobile phase pump 9 and the auto-sampler 12. In the example illustrated in FIG. 7, the Peltier element 22 is provided in a member constituting the ammonia filter column 11 having a large thermal capacity, for example, via an aluminum block and the like. Although it is not illustrated, the Peltier element 22 may be installed in place of the ammonia filter column 11, or the Peltier element 22 may be installed on the flow channel between the mobile phase pump 9 and the ammonia filter column 11 or between the ammonia filter column 11 and the auto-sampler 12.

In the cooling step, temperature adjustment by the Peltier element 22 is performed, and the temperature of the B1 liquid inside the flow channel is adjusted. In the pre-injection liquid feeding step, for example, temperature adjustment by the Peltier element 22 may end, or the temperature of the Peltier element 22 may be set to the initial temperature.

### Example 6

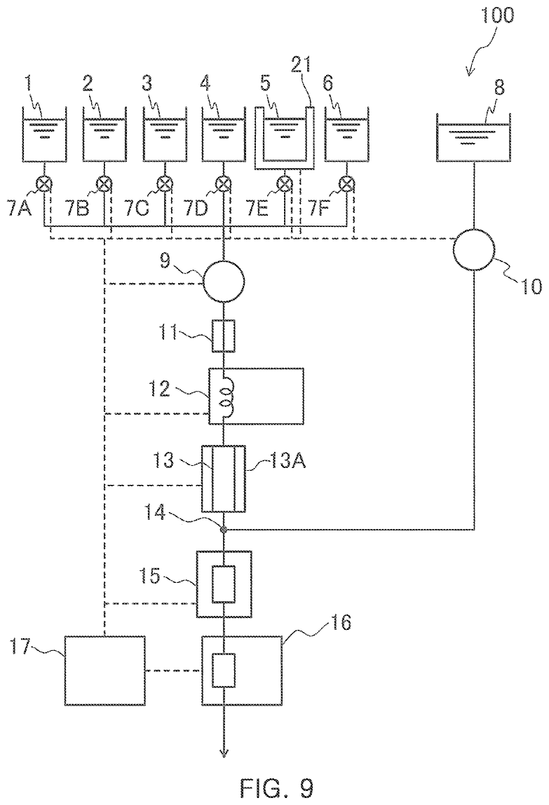

FIG. 8 is a schematic view of the device constitution and the flow channels of the amino acid analyzer 100 according to Example 6 of the present disclosure.

As illustrated in FIG. 8, the Peltier element 22 may be installed on the flow channel between the auto-sampler 12 and the separation column 13.

In the cooling step, temperature adjustment by the Peltier element 22 is performed, and the temperature of the B1 liquid inside the flow channel is adjusted. In the pre-injection liquid feeding step, for example, temperature adjustment by the Peltier element 22 may end, or the temperature of the Peltier element 22 may be set to the initial temperature.

### Example 7

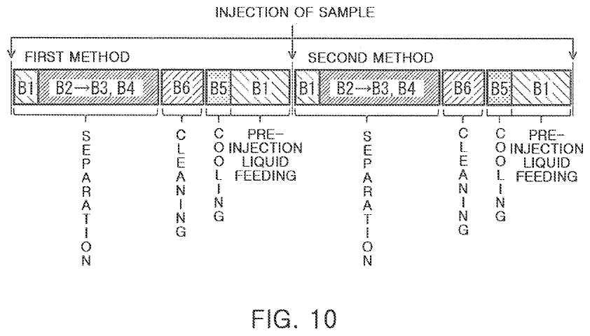

FIG. 9 is a schematic view of the device constitution and the flow channels of the amino acid analyzer 100 according to Example 7 of the present disclosure. FIG. 10 is a schematic view of a time table in a time program of the amino acid analyzer 100 according to the present Example.

From a viewpoint of shortening the analysis time, instead of an eluent for separation, it is conceivable to adopt a method in which the separation column 13 is promptly shifted to the initial state before the sample is injected by utilizing a dedicated adjustment liquid for adjusting the state of the separation column 13.

The adjustment liquid differs from an eluent and is not used for separation of sample components. Regarding the adjustment liquid, as described above, a low-salt concentration, a low-pH aqueous solution, and/or pure water such as distilled water can be utilized. Alternatively, an adjustment liquid having a higher salt concentration or an adjustment liquid having a higher pH aqueous solution than an eluent can also be used. The adjustment liquid is characterized by being out of the salt concentration range or the pH range of the eluent in order to be promptly shifted to the initial state before the sample is injected.

Specifically for example, as illustrated in FIGS. 9 and 10, the Peltier refrigerator 21 is installed on the container storing the distilled water 5, and the distilled water 5 subjected to temperature adjustment by the Peltier refrigerator 21 is introduced into the separation column in the cooling step. Accordingly, in addition to the temperature of the separation column 13, the salt concentration, the pH, and the like can also be quickly shifted to the initial state.

### Modification Example

Each of the foregoing Examples is constituted to be provided with the cooling step after the cleaning step and before the pre-injection liquid feeding step. However, the cooling step may be provided after the separating step and before the cleaning step. In addition, in Examples 1 to 6, the B1 liquid is constituted to be fed in the cooling step, but the B6 liquid may be fed. In this case, the cooling step may also include the cleaning step.

The present disclosure is not limited to the foregoing Examples and includes various modification examples. For example, the foregoing Examples have been described in detail in order to describe the present disclosure in an easy-to-understand manner and are not necessarily limited to those including all the constituents which have been described. In addition, a part of the constituents of certain Example can be replaced with constituents of other Examples. In addition, constituents of other Examples can also be added to the constituents of certain Example. In addition, regarding a part of the constituents of each Example, addition, deletion, or replacement of other constituents can be performed.

What is claimed is:

1. A liquid chromatograph comprising:
a liquid feeding portion which feeds a mobile phase to a flow channel;
a sample injection portion which is provided downstream of the liquid feeding portion in the flow channel and injects a sample into the mobile phase;
a separation column which is provided downstream of the sample injection portion in the flow channel and separates sample components in the sample;
a first temperature adjustment device which raises temperature of the separation column to a first temperature during separation of the sample components by the separation column; and
a detector which is provided downstream of the separation column in the flow channel and detects sample components separated by the separation column,
wherein the liquid chromatograph further comprises
a second temperature adjustment device which is provided upstream of the separation column in the flow channel and adjusts temperature of the mobile phase to a second temperature lower than the first temperature; and
a control device which controls at least one of the liquid feeding portion and the second temperature adjustment device,
wherein the control device controls at least one of the liquid feeding portion and the second temperature adjustment device such that the mobile phase adjusted to the second temperature is fed to the separation column before a next sample is injected after separation of the sample components by the separation column ends.

2. The liquid chromatograph according to claim 1,
wherein the liquid feeding portion includes a container storing the mobile phase, and
wherein the second temperature adjustment device is installed on the container.

3. The liquid chromatograph according to claim 1,
wherein the liquid feeding portion includes a container storing the mobile phase and a pump feeding the mobile phase in the container to the flow channel, and
wherein the second temperature adjustment device is installed on the flow channel between the container and the pump.

4. The liquid chromatograph according to any one of claim 1,
wherein the second temperature adjustment device is installed on the flow channel between the liquid feeding portion and the sample injection portion.

5. The liquid chromatograph according to any one of claim 1 further comprising:
an ammonia filter column which is disposed on the flow channel between the liquid feeding portion and the sample injection portion,
wherein the second temperature adjustment device is installed on the ammonia filter column.

6. The liquid chromatograph according to any one of claim 1,
wherein the second temperature adjustment device is installed on the flow channel between the sample injection portion and the separation column.

7. The liquid chromatograph according to any one of claim 1,
wherein the mobile phase includes two or more kinds of eluents including a first eluent and a second eluent which starts to be fed for separation of a sample later than the first eluent, and
wherein the second temperature adjustment device adjusts temperature of the first eluent.

8. The liquid chromatograph according to any one of claim 1,
wherein the mobile phase includes an adjustment liquid which is not used for separation of the sample, and
wherein the second temperature adjustment device adjusts temperature of the adjustment liquid.

9. The liquid chromatograph according to any one of claim 1,
wherein the liquid chromatograph is an ion exchange chromatograph.

10. The liquid chromatograph according to any one of claim 1,
wherein the liquid chromatograph is an amino acid analyzer for analyzing amino acids.
